(19) United States
(12) Patent Application Publication
(10) Pub. No.: US 2006/0074830 A1
(43) Pub. Date: Apr. 6, 2006

(54) System, method for deploying computing infrastructure, and method for constructing linearized classifiers with partially observable hidden states

(75) Inventor: Aleksandra Mojsilovic, New York, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/942,803

(22) Filed: Sep. 17, 2004

(51) Int. Cl. G06N 5/00; G06F 17/00

(52) U.S. Cl. 706/45

(57) ABSTRACT

A system (and method, and method for deploying computing infrastructure) for constructing a linearized classifier including a partially observable hidden state, includes training the classifier to determine a partially known hidden state in the model based on a relationship between an input and an output of the model.

### CROSS-REFERENCE TO RELATED APPLICATION

The present application is related to U.S. patent application Ser. No. 10/______, filed on Sep. 17, 2004, to Mojsilovic et al., entitled “SYSTEM, METHOD FOR DEPLOYING COMPUTING INFRASTRUCTURE, AND METHOD FOR IDENTIFYING CUSTOMERS AT RISK OF REVENUE CHANGE” having IBM Docket No. YOR920040246US1, which is incorporated herein by reference, in its entirety.

### BACKGROUND OF THE INVENTION

1. Field of the Invention

The present invention generally relates to data analysis and classification methods, and particularly, to a system, method for deploying computing infrastructure, and method for constructing linearized classifiers with partially observable hidden states, and more particularly, to a method for constructing and training traditional classifiers to discover partially known hidden states in the model and to capture complex relationships between measured inputs and observed outputs.

2. Description of the Related Art

Conventional classification and prediction methods merely are based on the use of known input-output relationships to estimate parameters of a mathematical model.

Examples of conventional classifiers include: 1) maximum likelihood (ML) estimators, which for a given set of observed inputs, and corresponding observed outputs, estimate the parameters of a model so as to maximize the likelihood of the outputs given the observations, 2) minimum mean square error (MMSE) estimators, which for a given set of observed inputs and corresponding observed outputs, estimate the parameters of a model so that the mean square error between the observed and predicted outputs is minimized, 3) support vector machines (SVM), which determine the parameters of a model by finding the “optimal” hyper-plane in a feature or feature-transformed space (e.g., a plane orthogonal to the shortest lane connecting the convex hulls of the two classes and intersecting it half-way).

In conventional classification and prediction methods, a set of inputs and set of outputs are used to try to build a model that will predict something (i.e., a model that will behave like the data set that is known). Thus, if an output is to be predicted from a set of inputs, most of conventional techniques work very well.

However, when there is a need to estimate hidden variables in the model (in addition to predicting the output), or when the input-output relationships are more complex and the data set that is used to train the model is small, the conventional methods and systems do not yield optimal results.

### SUMMARY OF THE INVENTION

In view of the foregoing, and other, exemplary problems, drawbacks, and disadvantages of the conventional systems, the unique and unobvious features of the present invention provide a novel and unobvious system and method for training classifiers and a system and method for estimating model parameters to provide optimal classification results with traditional models, when, for example, there is a need to estimate hidden states in the model, when there are complex non-linear relationships between input and output variables, etc.

One illustrative, non-limiting aspect of the invention provides a method for constructing a linearized classifier including partially observable hidden states, the method including training the classifier to determine partially known hidden states in the model based on relationships between inputs and outputs of the model.

In another exemplary aspect of the invention, the training further includes selecting the model from a plurality of models and the classifier from a plurality of classifiers.

In another exemplary aspect of the invention, the training further includes choosing an objective function from a plurality of objective functions for determining hidden states of the model, and estimating parameters of the model by optimizing a criterion function for the classifier, wherein the objective function between the hidden states and values computed from the model is less than a predetermined threshold.

In another exemplary aspect of the invention, an exemplary method further includes storing values of the parameters and a value of the criterion function.

In another exemplary aspect of the invention, the exemplary model includes at least one of a linear regression model, a logistic regression model, a nonlinear function model, and a kernel function for a support vector model.

In another exemplary aspect of the invention, an exemplary classifier includes at least one of a maximum likelihood classifier, a minimum mean square error classifier, a maximum a posteriori classifier, and a support vector machine classifier.

In another exemplary aspect of the invention, an exemplary objective function includes a mean square error between partially known values of the hidden states and corresponding values which are observed from the model.

In another exemplary aspect of the invention, an exemplary method includes choosing an input variable and constructing a one-step tree-classifier with respect to the input variable, estimating parameter values at each node of a plurality of nodes by minimizing a classification criterion for the classifier, computing a difference between an overall classification criterion function and values of classification criterion functions at two nodes of the plurality of nodes, and a change of each parameter between the two nodes, identifying a combination of variables which results in at least one of a largest decrease in classification criterion and a largest change in parameter values, constructing a second model by adding new inputs to the model that reflect at least one relationship between the identified combination of variables, and estimating parameters of the second model by minimizing the classification criterion for the classifier.

In another exemplary aspect of the invention, the objective function between partially known hidden states and corresponding values computed from the second model is smaller than a predetermined threshold.

In another exemplary aspect of the invention, the training further includes choosing an input variable and constructing a one-step tree-classifier with respect to the input variable, estimating parameter values at each node of a plurality of nodes by minimizing a classification criterion for the classifier, computing a difference between an overall classification criterion function and values of classification criterion functions at two nodes of the plurality of nodes, and a change of each parameter between the two nodes, identifying a combination of variables which results in at least one of a largest decrease in classification criterion and a largest change in parameter values, constructing a second model by adding new inputs to the model that reflect at least one relationship between the identified combination of variables, and estimating parameters of the second model by minimizing the classification criterion for the classifier.

In another exemplary aspect of the invention, the objective function between partially known hidden states and corresponding values computed from the second model is smaller than a predetermined threshold.

In another exemplary aspect of the invention, the at least one relationship includes a function of the identified combination of variables, wherein the function includes one of a quadratic term function, a multiplication function, a logistic function, and an exponential function.

In another exemplary aspect of the invention, the choosing, the estimating, and the computing are repeated until all variables of interest are explored.

In another exemplary aspect of the invention, if there is at least one of no information associated with the partially observable hidden states, and known relationships between values for some of the hidden states, the training further includes choosing an objective function from a plurality of objective functions for determining hidden states of the model, estimating parameter values of the model by optimizing a criterion function for the classifier and computing values of the hidden states from the model, and storing the parameter values, the hidden states, and a value of the criterion function.

In another exemplary aspect of the invention, an exemplary method further includes re-estimating the parameters of the model by optimizing the criterion function for the classifier.

In another exemplary aspect of the invention, the objective function between the new values for the hidden states and the values of the hidden states from the model is less than a predetermined threshold.

In another exemplary aspect of the invention, an exemplary method further includes choosing an input variable and constructing a one-step tree-classifier with respect to the input variable, estimating parameters at each node of a plurality of nodes by minimizing a classification criterion for the classifier, wherein an objective function between second values of the hidden states which reflect known relationships and corresponding values computed from the model is less than a predetermined threshold, computing a difference between an overall classification criterion function and values of the classification criterion function at two nodes of the plurality of nodes, and a change of each parameter between the two nodes, storing the values, repeating the choosing, the estimating, and the computing until all variables of interest are explored, identifying a combination of variables which results in at least one of a largest decrease in the classification criterion and a largest change in parameter values, constructing a second model by adding a new input to the model that reflects a relationship between the identified combination of variables, and estimating parameters of the second model by minimizing the classification criterion for the classifier.

In another exemplary aspect of the invention, if there is at least one of no information associated with the partially observable hidden states, and known relationships between values for some of the hidden states, the training further includes choosing an input variable and constructing a one-step tree-classifier with respect to the input variable, estimating parameters at each node of a plurality of nodes by minimizing a classification criterion for the classifier, wherein an objective function between second values of the hidden states which reflect known relationships and corresponding values computed from the model is less than a predetermined threshold, computing a difference between an overall classification criterion function and values of the classification criterion function at two nodes of the plurality of nodes, and a change of each parameter between the two nodes, storing the values, repeating the choosing, the estimating, and the computing until all variables of interest are explored, identifying a combination of variables which results in at least one of a largest decrease in the classification criterion and a largest change in parameter values, constructing a second model by adding a new input to the first model that reflects a relationship between the identified combination of variables, and estimating parameters of the second model by minimizing the classification criterion for the selected classifier, wherein the objective function between partially known hidden states and corresponding values computed from the model is less than a predetermined threshold.

In another exemplary aspect of the invention, an exemplary method further includes storing values of the parameters and a value of the criterion function.

In another exemplary aspect of the invention, a system of constructing linearized classifiers including partially observable hidden states, the system includes a training module that trains the classifier to determine partially known hidden states in the model based on relationships between inputs and outputs of the model.

In another exemplary aspect of the invention, the training module further includes a selecting unit that selects the model from a plurality of models and the classifier from a plurality of classifiers.

In another exemplary aspect of the invention, the training module further includes a choosing unit that chooses an objective function from a plurality of objective functions for determining hidden states of the model, and an estimating unit that estimates parameters of the model by optimizing a criterion function for the classifier, wherein the objective function between the hidden states and values computed from the model is less than a predetermined threshold.

In another exemplary aspect of the invention, an exemplary system further includes a storing unit that stores values of the parameters and a value of the criterion function.

In another exemplary aspect of the invention, one of the plurality of objective functions includes a mean square error between partially known values of the hidden states and corresponding values which are observed from the model.

In another exemplary aspect of the invention, the training module further includes a choosing unit that chooses an input variable and constructs a one-step tree-classifier with respect to the input variable, an estimating unit that estimates parameter values at each node of a plurality of nodes by minimizing a classification criterion for the classifier, a computing unit that computes a difference between an overall classification criterion function and values of classification criterion functions at two nodes of the plurality of nodes, and a change of each parameter between the two nodes, an identifying unit that identifies a combination of variables which results in at least one of a largest decrease in classification criterion and a largest change in parameter values, and a constructing unit that constructs a second model by adding new inputs to the first model that reflect at least one relationship between the identified combination of variables.

In another exemplary aspect of the invention, the choosing unit, the estimating unit, and computing unit are adapted to explore all variables of interest.

In another exemplary aspect of the invention, if there is at least one of no information associated with the plurality of observable hidden states, and known relationships between values for some of the hidden states, the training module further includes a choosing unit that chooses an objective function from a plurality of objective functions for determining hidden states of the model, an estimating unit that estimates parameter values of the model by optimizing a criterion function for the classifier and computes values of the hidden states from the model, a storing unit that stores the parameter values, the hidden states, and a value of the criterion function, and a changing unit that changes the computed values of the hidden states to reflect known relationships to determine second values for the hidden states.

In another exemplary aspect of the invention, if there is at least one of no information associated with the plurality of observable hidden states, and known relationships between values for some of the hidden states, the training module further includes a choosing unit that chooses an input variable and constructing a one-step tree-classifier with respect to the input variable, an estimating unit that estimates parameters at each node of a plurality of nodes by minimizing a classification criterion for the classifier, wherein an objective function between second values of the hidden states which reflect known relationships and corresponding values computed from the model is less than a predetermined threshold, a computing unit that computes a difference between an overall classification criterion function and values of the classification criterion function at two nodes of the plurality of nodes and computes a change of each parameter between the two nodes, a storing unit that stores the values, wherein the choosing unit and the estimating until are adapted to explore all variables of interest, an identifying unit that identifies a combination of variables which results in at least one of a largest decrease in the classification criterion and a largest change in parameter values, and a constructing unit that constructs a second model by adding a new input to the first model that reflects a relationship between the identified combination of variables, wherein the estimating unit estimates parameters of the second model by minimizing the classification criterion for the classifier, and wherein the objective function between partially known hidden states and corresponding values computed from the model is less than a predetermined threshold.

In another exemplary aspect of the invention, a system of constructing linearized classifiers including partially observable hidden states, the system including means for training the classifier to determine partially known hidden states in the model based on relationships between inputs and outputs of the model.

In another exemplary aspect of the invention, the means for training further includes means for selecting the model from a plurality of models and the classifier from a plurality of classifiers, means for choosing an objective function from a plurality of objective functions for determining hidden states of the model, and wherein, if partial information associated with the hidden states is available, the means for training further includes means for estimating parameters of the model by optimizing a criterion function for the classifier, wherein the objective function between the hidden states and values computed from the model is less than a predetermined threshold.

In another exemplary aspect of the invention, if at least one of the partial information associated with the hidden states is not available and relationships between the hidden states are available, the system further includes means for estimating parameter values of the model by optimizing a criterion function for the classifier, means for computing values of the hidden states from the model, and means for changing the computed values of the hidden states to reflect known relationships to determine second values for the hidden states.

In another exemplary aspect of the invention, an exemplary system includes means for choosing an input variable and constructing a one-step tree-classifier with respect to the input variable, means for estimating parameter values at each node of a plurality of nodes by minimizing a classification criterion for the classifier, means for computing a difference between an overall classification criterion function and values of classification criterion functions at two nodes of the plurality of nodes, and a change of each parameter between the two nodes, means for identifying a combination of variables which results in at least one of a largest decrease in classification criterion and a largest change in parameter values, and means for constructing a second model by adding new inputs to the first model that reflect at least one relationship between the identified combination of variables, wherein the means for estimating estimates parameters of the second model by minimizing the classification criterion for the classifier.

In another exemplary aspect of the invention, a signal-bearing medium tangibly embodying a program of machine-readable instructions executable by a digital processing apparatus to perform a method for constructing linearized classifiers including partially observable hidden states, the method including training the classifier to determine partially known hidden states in the model based on relationships between inputs and outputs of the model.

In another exemplary aspect of the invention, a method for deploying computing infrastructure in which computer-readable code is integrated into a computing system, and combines with the computing system to perform a method for constructing linearized classifiers including partially observable hidden states, the method including training the classifier to determine partially known hidden states in the model based on relationships between inputs and outputs of the model.

The unique and unobvious features of the present invention provide a novel and unobvious system and method for training classifiers and a system and method for estimating model parameters to provide optimal classification results with traditional models, when, for example, there is a need to estimate hidden states in the model, or when there is a need to capture complex non-linear relationships between input and output variables with small training sets.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary portion of a flow chart of an exemplary, non-limiting embodiment of a method 100 according to the present invention;

FIG. 2 illustrates another exemplary portion of the flow chart of the exemplary method 100 according to the present invention;

FIG. 3 illustrates another exemplary portion of the flow chart of the exemplary method 100 according to the present invention;

FIG. 4 illustrates an exemplary, non-limiting embodiment of a system 400 according to the present invention;

FIG. 5 illustrates an exemplary, non-limiting embodiment of a system 500 according to the present invention;

FIG. 6 illustrates another exemplary, non-limiting embodiment of a method 600 according to the present invention;

FIG. 7 illustrates another exemplary, non-limiting aspect of the present invention;

FIG. 8 illustrates a conventional method 800;

FIG. 9 illustrates exemplary, non-limiting embodiments of an exemplary system and method according to the present invention;

FIG. 10 illustrates another exemplary, non-limiting aspect of the present invention;

FIG. 11 illustrates another exemplary, non-limiting aspect of the present invention;

FIG. 12 illustrates another exemplary, non-limiting aspect of the present invention;

FIG. 13 illustrates another exemplary, non-limiting aspect 1300 according to the present invention;

FIG. 14 illustrates another exemplary, non-limiting embodiment of a system 1400 according to the present invention;

FIG. 15 illustrates an exemplary hardware/information handling system 1500 for incorporating the present invention therein; and

FIG. 16 illustrates a signal bearing medium 1600 (e.g., storage medium) for storing steps of a program of a method according to the present invention.

### DETAILED DESCRIPTION OF EXEMPLARY EMBODIMENTS OF THE INVENTION

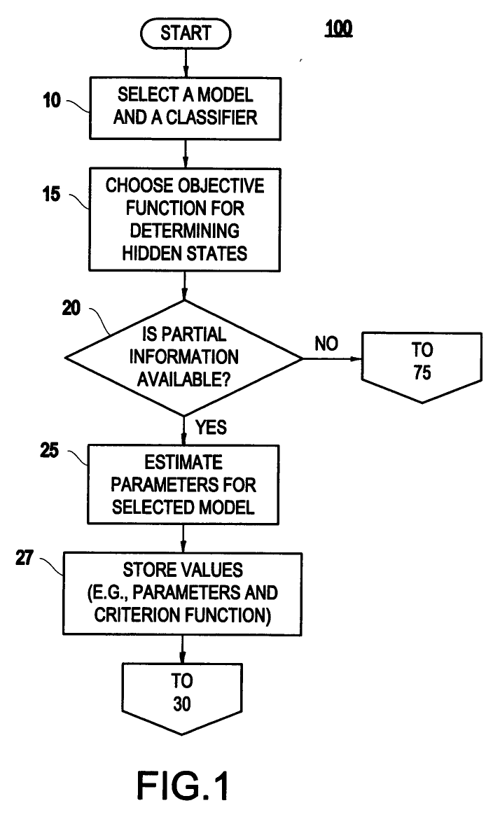

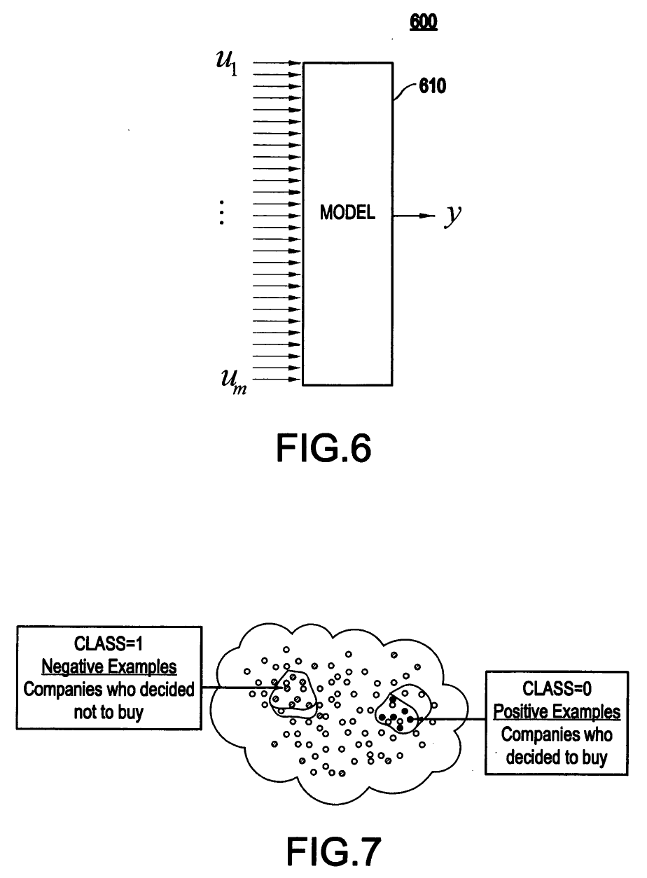

Referring now to the drawings, and more particularly to FIGS. 1-16, there are shown exemplary embodiments of the method and systems according to the present invention.

There are many practical applications that need classification methods capable of learning complex relationships from extremely small training sets.

For example, such practical applications can include: 1) business process modeling and forecasting (e.g., deciding whether a company is at risk (e.g., financially), determining why such company is at risk, deciding whether to pursue an investment into a project, and evaluating a business action of a company), 2) quality of software engineering, 3) analysis of manufacturing data in computer controlled manufacturing, to avoid settings that are more likely to produce a defective product or increase likelihood of excellent quality, and/or 4) portfolio tracking and dashboard design to monitor account health.

In some cases, conventional or traditional classifiers, such as the three aforementioned examples set forth in the Related Art section above can be applied to these types of problems but will yield sub-optimal results. Accordingly, there are certain cases where the conventional systems and methods cannot provide optimal results and are not reliable.

For example, as illustrated in the exemplary aspects of the invention set forth below, given a set of measured inputs and corresponding observed outputs, it may be desirable to estimate both the parameters of the model and several hidden (but observable states) if partial, a priori information about the states is available.

An illustrative example of a problem of this type is developing a dashboard to track a portfolio of potential new customers and targeting those who are more likely to buy a new product or new service from a providing company. In this case, the inputs to the model are numerous variables that describe, for example: 1) financial health, business performance and cash potential of tracked companies, 2) previous relationships with the providing company, 3) price and competitiveness of the offered product or service, and 4) significant events from the tracked companies, which could have a potential impact to the decision to buy a new product or service.

In the aforementioned example, the output variable that needs to be estimated is the likelihood that a potential customer will buy an offered product or service from the providing company. However, the conventional or traditional classification methods are limited in ability to design a dashboard that will capture the richness of this problem. That is, traditional methods applied to this problem are limited to estimating the likelihood of buying a product, without providing insights into which of the external factors are most influential in the decision.

As illustrated in the exemplary embodiment of the present invention set forth below, knowing the impact of different factors to the decision of a potential customer can help a providing company (e.g., company A) influence the final outcome or improve the quality of the relationship with another entity (e.g., a client, customer, etc., such as company B, C, etc.).

For example, if a decision not to buy is based on the limited cash availability of the customer, the providing company might be able to architect different ways of financing for the customers with lower liquidity.

On the other hand, if a decision is formed based on the previous dissatisfaction with the product, the providing company might be able to address this issue by improving its sales and marketing practices, or improving the existing relationship with the customer. These “internal factors” are typically not known a priori. That is, the factors are not known, but instead, only the variables that influence these factors are known.

These “internal factors” can be defined as hidden but observable states in the model.

In the conventional methods, after the parameters of the model have been estimated, the values of these states merely are computed as a “bi-product” of the model. That is, the conventional methods do not directly determine the parameters.

However, in many applications, at least some information is available or known concerning the relationships among these factors (i.e., hidden variables).

For example, in the aforementioned problem of the dashboard design, it is often possible to provide additional information, such as known relationships (e.g., company A has been more satisfied than company B, or company C has better financial health than company D). In such exemplary cases, the estimation of hidden variables obtained with standard parameter estimation procedures is not optimal or reliable, since the traditional classification models are trained without taking into account these known relationships. Thus, the estimation of hidden variables obtained with conventional or standard parameter estimation procedures is unreliable.

On the other hand, as illustrated in the exemplary embodiments of the present invention set forth below, given a small set of input-output examples, it may be desirable to estimate the parameters of a simple model, so as to capture complex non-linear input-output relationships in the data.

While conventional learning algorithms produce sufficiently accurate methods for many applications, the conventional methods suffer from many limitations when working with small data sets (and especially when there are complex non-linear relationships among the variables).

As illustrated in the exemplary embodiments of the present invention set forth below, if such limitations were overcome, the performance of the data classification and regression systems that employ such models could be greatly improved.

However, in the conventional methods, the small size of the training set severely limits the selection of the model to the simplest structures, which do not account for more complex non-linear relationships in the data that are to be discovered in the training phase.

For example, the tree-based classifiers that effectively capture complex relationships in data cannot be applied at all if the training set is small (e.g., for purposes of the exemplary aspects of the present invention, “small” generally is defined as a case in which the optimal ratio M/K is approximately between 2 and 10 (and more particularly, between 2 and 6), where M is the number of data points and K is the number of inputs for the particular model being used).

For example, a “small” data set according to an exemplary aspect of the present invention could include a case where there are 50 data points and 10 inputs. Thus, the “small” size of the data set generally depends on how many inputs are needed for a particular model being used, since the predetermined number (e.g., predetermined threshold) of inputs generally depends on the model being used.

Moreover, the small size of the training set also limits the number of input variables. Thus, increasing the number of input variables in the model increases the number of free-parameters. This results in a deteriorating performance (i.e., as a result of dimensionality), which is due to the mismatch between the size of the training set and the number of free parameters.

The above problem with the deteriorating performance (i.e., as a result of dimensionality) can be overcome, for example, with support vector machine-like (SVM-like) models that operate in sparsely populated feature spaces. Such models rely on the observed relationships between the number of training samples m, number of features k, and the generalization error of the classifier.

Namely, for many traditional classifiers trained by m objects, the generalization error e(k) increases with the increase in feature size, and reaches the maximum at about k=m (the “peaking phenomenon”).

However, the present invention has discovered that after the maximum is reached, in cases when the sample size is significantly smaller that the feature size (m<k), it is possible to obtain classification performances that are much better than those obtained with “sound” feature sizes. However, in many applications it is not possible to select a large number of features as required by such an approach.

Thus, the present invention provides a system and method for training classifiers and for estimating model parameters to provide optimal classification results with traditional models, when, for example, there is a need to estimate hidden states in the model, when there are complex non-linear relationships between input and output variables, etc.

The exemplary embodiments of the present application provide classification methods, systems, and training procedures for known classifiers that will capture such relationships in the data. Moreover, the exemplary embodiments of the present invention provide simple models, which can be constructed from small training samples to capture the complex input-output relationships.

As mentioned above, there are many practical applications that need classification methods capable of learning rich and complex relationships from extremely small training sets, for example: 1) business process modeling and forecasting (e.g., deciding if a company is at risk or not and why, deciding weather to pursue an investment into a project, evaluating a business action of a company), 2) quality of software engineering, 3) analysis of manufacturing data in computer controlled manufacturing, to avoid settings that are more likely to produce a defective product or increase likelihood of excellent quality, and/or 4) portfolio tracking and dashboard design to monitor account health.

In such complicated and complex relationships, the conventional models are deficient and the results clearly are not optimal. For example, the conventional systems and methods merely use a set of inputs and set of outputs to try to build a model that will behave like the data set that is known such that the model will predict something. Thus, if merely an output from a set of inputs is to be predicted, most conventional techniques work very well.

However, there is a problem that when the conventional methods are applied to a more difficult problem, the data set that is being used to train the model is smaller. Similarly, if the data is very complicated or has very complicated relationships, most conventional techniques will not work very well.

The exemplary embodiments of the present invention provide systems and methods of training the models of conventional methods in a different way to make use of, or get out as much as possible, from the data that is available to train the model.

For example, as mentioned above, when the data set is small, very elegant models cannot be achieved. Thus, the exemplary embodiments of the present invention provide a special kind of training such that a very simple model can be used that will behave close to very complicated models that cannot be used because of the data set that is available (i.e., very small data set).

It is noted that the size of the data set that can be used depends on how many inputs are needed for the particular model being used. For example, if 50 data points will be used to train the model, then the model may only permit the use of 10-15 variables. In other words, if it is desired to predict the behavior of a set of customers, and there are 50 examples of the customers' prior history or previous behavior available, then it may only be possible to input up to 10-15 financial metrics or other metrics into the model. If too many input variables are used, then the model will start to behave very strangely and will lead to some misclassification. It is noted that there are statistics and well-known studies that describe the relationships between how many data points are available and how many inputs to the model that can be used based on the data points available.

As another example, when a large data set is available, and also when the model is non-linear (i.e., there are very complicated relationships which are to be captured, models that are based on different tree structures generally are used. In such cases, the data is split into different categories and then a different model is built for each category.

However, there is a problem that, when there is very little data available, the data cannot be split into different subsets because those subsets will be too small to facilitate building a model for any of the subsets. Thus, as mentioned above, sophisticated techniques cannot be relied upon or used to capture such more complicated relationships.

Thus, a technique is needed that will start from a very simple model and change it very slightly in a special way to simulate behavior that otherwise could be obtained with more complicated structures if an adequate number of data points were available.

To solve the aforementioned problem, in the exemplary embodiments of the present invention, the model itself is designed to handle the situations where there are few data points, in which it would not be possible to use the conventional models that are more complex.

As mentioned above, typically the models that are used in these problems are used to predict a set of outputs from a set of inputs. That is, if financial metrics and/or a customer survey are known, then it may be possible to predict whether company B is going to leave company A (e.g., whether the customer is going to leave the service or product provider).

However, in these problems, very often there are other things that would be beneficial to estimate, in addition to whether company A is going to leave company B. For example, it may be beneficial to know why company A is going to leave company B, and/or what are the key factors that are contributing company A's decision to leave company B.

However, company B generally does not have records of why company A is leaving. Instead, the information available generally is only an indication of, or relationships between factors with respect to one company, or relationships between one or two companies (e.g., company B had worse financial performance than company C).

Thus, one of the exemplary features of the claimed invention is to use very limited partial knowledge of prior history or prior relationships to train a model to capture these relationships in order to help estimate the hidden risk factors that usually cannot be estimated directly from the model.

Thus, the exemplary system and method according to the present invention helps to train existing classifiers to train a model in a different way.

For example, the exemplary method adds different steps or modifies the steps of a conventional model training procedure, thereby changing the training procedure to help deal with, for example, these hidden states and the small data sets.

In the conventional model, the method generally decides what type of model (e.g., what type of classifier) to use, and then estimates the parameters of the model by optimizing the criterion for the selected classifier.

On the other hand, the exemplary method according to the present invention adds new steps and changes the conventional procedure entirely to deal with the above mentioned problems.

For example, in one aspect of the exemplary method according to the present invention, there is some partial information available (e.g., the values for some of the hidden states are already known or available).

On the other hand, in another aspect of the exemplary method according to the present invention, the values for some of the hidden states, or some of the companies, are not known, but it is known that there are some relationships, and preferably, these relationships also are known (e.g., it is known that company B was performing worse than company C, it was known that company B liked company A's service better than company C liked company A's services, or it was known that company C was in the process of restructuring).

In other words, there are relationships that are known, but the actual values that are to be captured are not known.

As another example, in the conventional methods, if there are some hidden states or some hidden variables in the model that it is desirable to predict, in addition to the overall output, the conventional methods do not provide any training data to help predict or learn about these hidden variables. Thus, the conventional methods cannot do anything because they will just learn input output relationships (i.e., they have no material to learn from and they do not provide a method for learning the hidden variables).

In comparison, the exemplary system and method according the present invention can teach the conventional model to discover these hidden relationships based on some very limited knowledge that is available or known.

For example, when trying to build a model to predict if company B is going to buy a product or service from company A, there are several factors that may influence, for example, a customer's (e.g., company B's) decision to buy or not to buy a product or service from a product or service provider (e.g., company A).

For example, these factors may include, among others, 1) whether company B has enough money (e.g., financial performance), 2) whether company B purchased from company A in the past, and if so, have they been satisfied with that product or service, 3) the price of the product and if there are any competitors products (e.g., alternative products) in the market (e.g., are they more expensive or less expensive), 4) any changes in company B (e.g., if company B is planning to do a major restructuring, then company B may not need products or services from company A anymore).

In training the model according to the exemplary methods of the present invention, the data that is intended to capture the client's financial performance (e.g., financial metrics and/or risk factors) are fed into the system. The data that can be fed into the system (or method) is not limited and can be any information, such as information with respect to the competition and/or a competitor's product, different news about that product, and various different metrics, etc.

The model according to the exemplary aspects of the present invention can be taught to whether or not company B is likely to buy products from company A.

However, it is desirable to provide company A's executives and/or company A's client additional information with respect to which one of the factors (e.g., financial performance, client satisfaction, product satisfaction, price and competitiveness, and/or significant developments, etc.) is driving company B's decision to buy (or not to buy).

For example, if it can be determined that company B does not want to buy company A's product or service because they can't afford it, company A can evaluate ways to make the products or services affordable to company B (e.g., by giving company B a rebate to decrease the price, or design some line of credit to help company B buy that product). On the other hand, if there is a problem in client satisfaction, company A may want to change their marketing campaign.

As mentioned above, the conventional methods can only reliably predict the fact that company B will or will not buy company A's product or services. In other words, the conventional methods will not be able to predict which one of the aforementioned factors is driving company B's decision.

On the other hand, the exemplary aspects of the present invention provide a system and method in which a prediction or probability can determine that, e.g. financial performance is the key decision to buy or not to buy.

In the exemplary aspects of the present invention, when some of the relationships (e.g., some of these values for some of the customers) are known, the present invention can retrain the conventional models, by teaching the model differently through a better training procedure, to enable the model to estimate these hidden factors in a more reliable way.

Thus, the exemplary aspects of the present invention use either the known hidden states or the modified hidden states, the partial data (partial information), or hidden data.

In the exemplary aspects of the present invention, the model is trained based on other information or data that is known (e.g., profitability on company B and company C) to better train the model such that when the model predicts which of those influencers was the key factor, the reliability is greatly improved over what the conventional methods can produce.

That is, according to the exemplary aspects of the present invention, when the hidden variables are not known, but relationships between the hidden variables are known, these relationships can be fed into the model to train the model such that the hidden variables can be predicted, such as which factor contributed to an event (e.g., a failure, a defect, or a company terminating its relationship with another company).

Accordingly, unlike the conventional methods, the present invention permits training of a model to capture the hidden states by addressing the fact that hidden states are present.

The exemplary aspects of the present invention can generally be used in any problem where other information, data, influencers, and/or the groups of variables that contribute to the hidden states are known. For example, the exemplary aspects of the present invention could be used in evaluating manufacturing and control systems, in which a large number of items are measured (e.g., pressure, temperature, computer controls, etc., in a power plant). In such cases, it may be desirable to determine what factors contribute to failures or defective products or services (e.g., overall plant design, problems with the computer controls, human error, etc.).

As illustrated in FIGS. 1-3, an exemplary method according to the invention allows for the estimation of hidden, yet observable states, for which there is some (e.g., partial) information available. On the other hand, if there is no partial information available, the exemplary embodiments of the present invention permit the estimation of parameters based on known relationships between the values of some of the states.

As illustrated in FIG. 1, an exemplary method 100 according to the present invention selects (e.g., step 10) the structure of the model (e.g. linear regression, logistic regression, certain nonlinear function, the type of kernel function for the SVM model, etc.) and the type of classifier (e.g. maximum likelihood, minimum mean square error, maximum a posteriori, support vector machines, etc.).

Next, the exemplary method 100 chooses (e.g., step 15) an objective function to be used in determining the hidden states of the model (e.g. mean square error between the partially known values of the hidden states and the corresponding values that are observed from the model directly).

If there is partial information available (e.g., step 20), then the exemplary method 100 estimates (e.g., step 25) the parameters of the model by optimizing the criterion function for the selected classifier, subject to the constraint that the objective function between the partially known hidden states and the values that are computed from the model is smaller than a predefined threshold. The values are then stored (e.g., step 27) (e.g., the values of the parameters and the value of the criterion function).

Another exemplary feature of the present invention is that it can address the problem in which there is not enough data to use the sophisticated, conventional systems and methods.

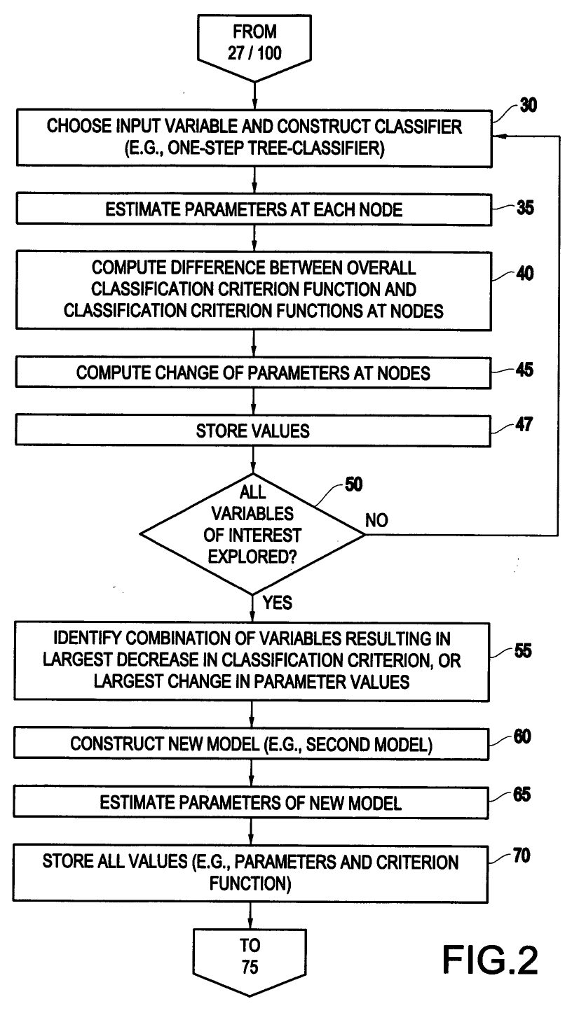

In such cases, as shown in FIG. 2, the exemplary aspects of the present invention provide a method that can choose (e.g., step 30) one input variable and construct one-step tree-classifier with respect to the given variable. The exemplary method then estimates (e.g., step 35) the parameters at each node by minimizing the classification criterion for the selected classifier, subject to the constraint that the objective function between the partially known hidden states and corresponding values that are computed from the model directly is smaller than a predefined threshold.

Next, a measure of the difference between the overall classification criterion function and the values of classification criterion functions at the two nodes is computed (e.g., step 40). The measure of the change of each parameter between the two nodes also is computed (e.g., step 45) and the all of the values are stored (e.g., step 47). The estimating and computing can be repeated (e.g., step 50) until all variables of interest are explored.

The combination of variables that resulted in the largest decrease in classification criterion, or the largest change in parameter values, is identified (e.g., step 55).

A new model is constructed (e.g., step 60) by adding new inputs to the model that reflect the relationships between the identified variables (e.g., the identified variables only). It is noted that the relationships are not limited to any particular relationships and can be, for example, any function of the identified variables, such as quadratic term, multiplication, logistic function, or exponential function, etc.

The parameters of the final model are estimated (e.g., step 65) by minimizing the classification criterion for the selected classifier, subject to the constraint that the objective function between the partially known hidden states and corresponding values that are computed from the model directly is smaller than a predefined threshold. The values (e.g., the values of the parameters and the value of the criterion function) are then stored (e.g., step 70).

It is noted that the training method according to the above exemplary aspect is not limited to any type of classifier, any specific model structure, or any specific objective function. The ordinarily skilled artisan will recognize that the exemplary method easily can be modified to include any other classification algorithm where the abovementioned exemplary method is applicable.

On the other hand, another exemplary aspect of the present invention allows for the estimation of hidden, yet observable states, for which there is no information available, but for which there are known relationships between the values for some of the states.

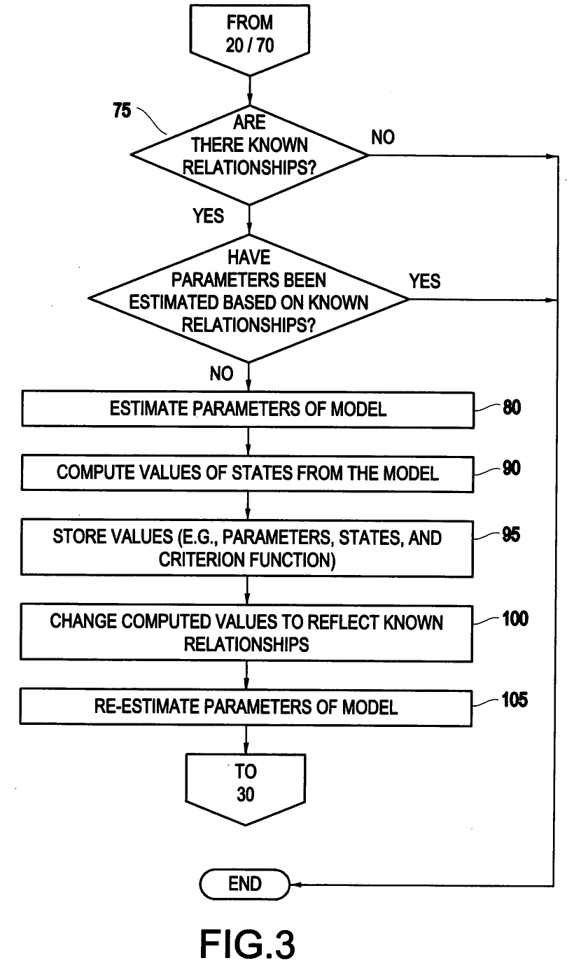

For example, as illustrated in FIG. 3, in an exemplary method 100, if there are known relationships between the values for some of the states, the exemplary method 100 can estimate (e.g., step 80) the parameters of the model by optimizing the criterion function for the selected classifier and compute (e.g., step 85) the values of the states from the model directly. The values (e.g., values of the parameters, states, and/or the value of the criterion function) are stored (e.g., step 95).

Next, the exemplary method 100 changes (e.g., step 100) the computed values of the states from the model to reflect the known relationships and then re-estimates (e.g., step 105) the parameters of the model by optimizing the criterion function for the selected classifier, subject to the constraint that the objective function between the new values for the hidden states (as determined above) and the values that are computed from the model is smaller than a predetermined threshold.

As illustrated in FIG. 2, an exemplary method according to the present invention further can include choosing (e.g., step 30) one input variable and constructing a one-step tree-classifier with respect to the given variable. The exemplary aspect can then estimate (e.g., step 35) the parameters at each node by minimizing the classification criterion for the selected classifier, subject to the constraint that the objective function between the new values of the hidden states (as determined, for example, in the exemplary aspect illustrated in FIG. 1 or FIG. 3) and corresponding values computed from the model directly is smaller than a predetermined threshold. The exemplary method also can compute (e.g., step 45) the measure of a difference between the overall classification criterion function and the values of classification criterion functions at the two nodes, and the measure of a change of each parameter between the two nodes. At this point, the exemplary method can store (e.g., step 47) all the values.

In the exemplary method, the steps of choosing, estimating, and computing can be repeated (e.g., step 50) until all variables of interest are explored.

Next, the exemplary method identifies (e.g., step 55) a combination of variables that result in the largest decrease in classification criterion, or the largest change in parameter values and constructs (e.g., step 60) a new model by adding a new input to the model that reflects a relationship between the identified variables (e.g., the identified variables only). It is noted that, in the exemplary aspects of the present invention, the relationship can be any function of the identified variables, such as quadratic term, multiplication, logistic function or exponential function, etc.

The exemplary method can estimate the parameters of the final model (as constructed above) (e.g., the second model) by minimizing the classification criterion for the selected classifier, subject to the constraint that the objective function between the partially known hidden states and corresponding values that are computed from the model directly is smaller than a predetermined threshold. The exemplary method again can store (e.g., step 70) the values (e.g., the values of the parameters, and the value of the criterion function).

It is important to emphasize that the training methodology according to the exemplary aspects of the present invention are not limited to any type of classifier, any specific model structure, or any specific objective function. It would be understandable to an ordinarily skilled artisan that the exemplary aspects can be modified to include any other classification algorithm where the abovementioned methodology is applicable, without the spirit and scope of the present invention.

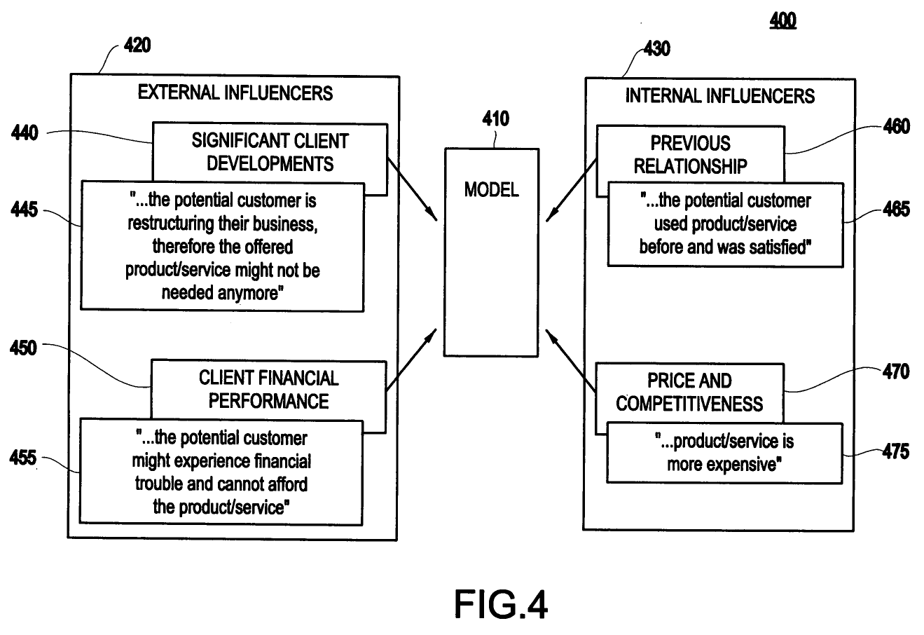

As exemplarily illustrated in FIG. 4, a system 400 according to an exemplary aspect of the present invention can construct classifiers including a model that receives, for example, external (e.g., 420) and internal influencers (e.g., 430) associated with an entity (e.g., a customer, client, or company).

The external influencers (e.g., 420) can include significant client developments (e.g., 440), such as whether a potential or existing customer is restructuring their business, which may indicate that an offered product or service might not be needed by the customer anymore (e.g., 445), and/or client financial performance metrics (e.g., 450), such as whether the potential or existing customer might experience, or has experienced, financial trouble, which may indicate that the customer cannot afford (or will not be able to afford in the future) a product or service (e.g., 455).

The internal influencers (e.g., 430) can include previous relationship information (e.g., 460), such as whether the potential or existing customer used a product or service before and was satisfied (i.e., customer satisfaction surveys) (e.g., 460), and/or price and competitiveness information (e.g., 470), such as whether a product or service is more or less expensive that competitors' product or services (e.g., 475).

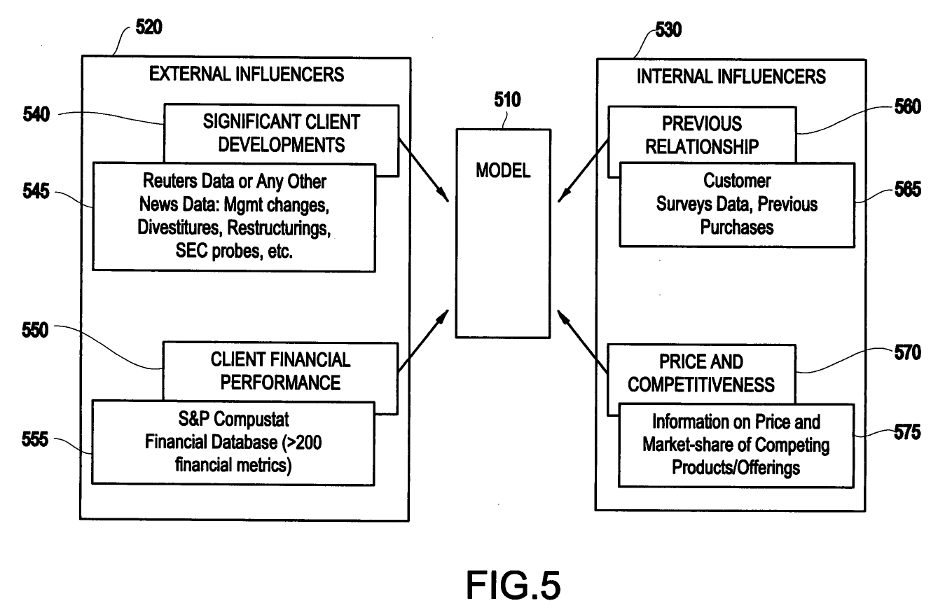

In another exemplary aspect of the present invention, as illustrated in the system 500 of FIG. 5, the external influencers (e.g., 520) can include significant client developments (e.g., 540), such as Reuters data or any other news data, including, for example, management changes, divestitures, restructurings, governmental probes (e.g., SEC probes), etc.

The exemplary aspect of the system 500 may additionally or alternatively include client financial performance metrics (e.g., 550), such as financial metrics from the S&P Compustat Financial Database (e.g., over 200 financial metrics), among other sources (e.g., 520) The internal influencers (e.g., 530) can include previous relationship information (e.g., 560), such as customer surveys data and/or previous purchase information (e.g., 530), and/or price and competitiveness information (e.g., 570), such as information on price and market-share of competing products and/or services offered (e.g., 575).

As illustrated in an exemplary aspect of the present invention, in an exemplary method 600, the output variable that needs to be estimated is the likelihood (e.g., y) that a potential or existing customer (e.g., company B or company C) will buy an offered product or service from the providing company (e.g., company A), for example, based on the known relationships (e.g., influencers u₁-uₘ) being input to model 610.

As illustrated in an exemplary aspect of the present invention, the training set can be derived from all previous examples (e.g., historic data, known relationships, etc.) of customers, for example, who decided to buy or not to buy a product or service of the providing company (e.g., company A). Particularly, class 1 could include negative examples, or examples in which the company (e.g., company B or C) decided not to buy another companies (e.g., company A's products or services). On the other hand, class 0 could include positive examples, or examples in which the company (e.g., company B or C) decided to buy another companies (e.g., company A's products or services).

FIG. 7 illustrates an exemplary process of building the training set in case of traditional classifiers, by specifying examples from each class.

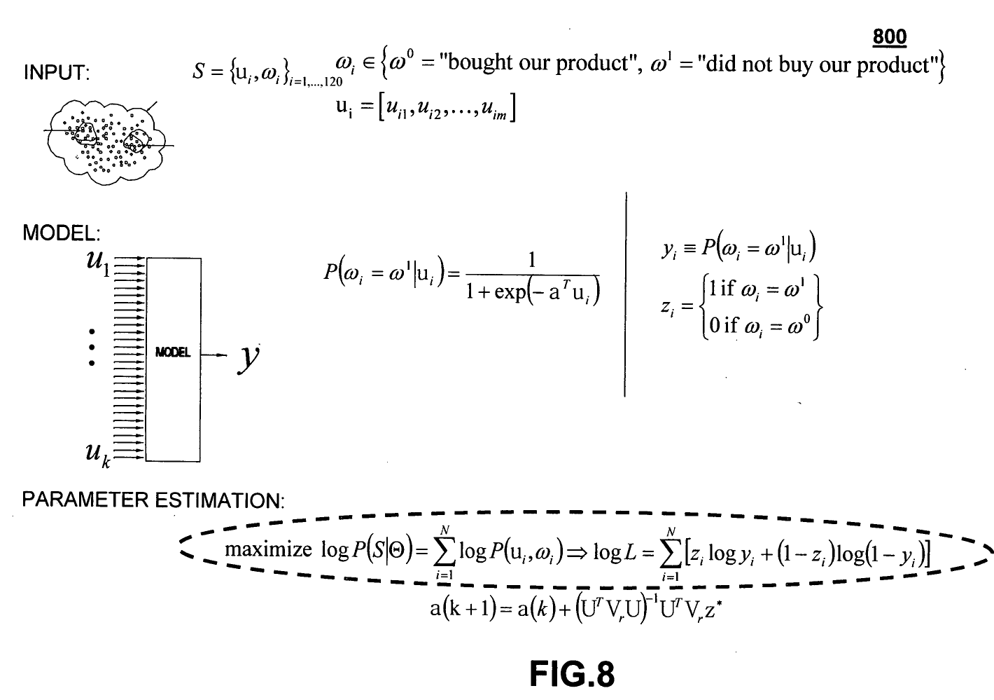

FIG. 8 illustrates an example of a conventional or commonly used technique that can be used to train the model to predict what is desired to be predicted (e.g., applying a traditional classifier to solve a problem, such as logistic regression). Specifically, the parameters of the model are determined by maximizing the log-likelihood function LogP(S|O). FIG. 8 also illustrates a commonly used update rule to compute the parameters of the model, a.

However, in addition to estimating the likelihood that an entity, client, or customer (e.g., company B, company C, etc.) will buy a product or service from a provider (e.g., company A), the present invention has identified that it is useful and desirable to know which factors influence the decision to buy (or not to buy) the product or services.

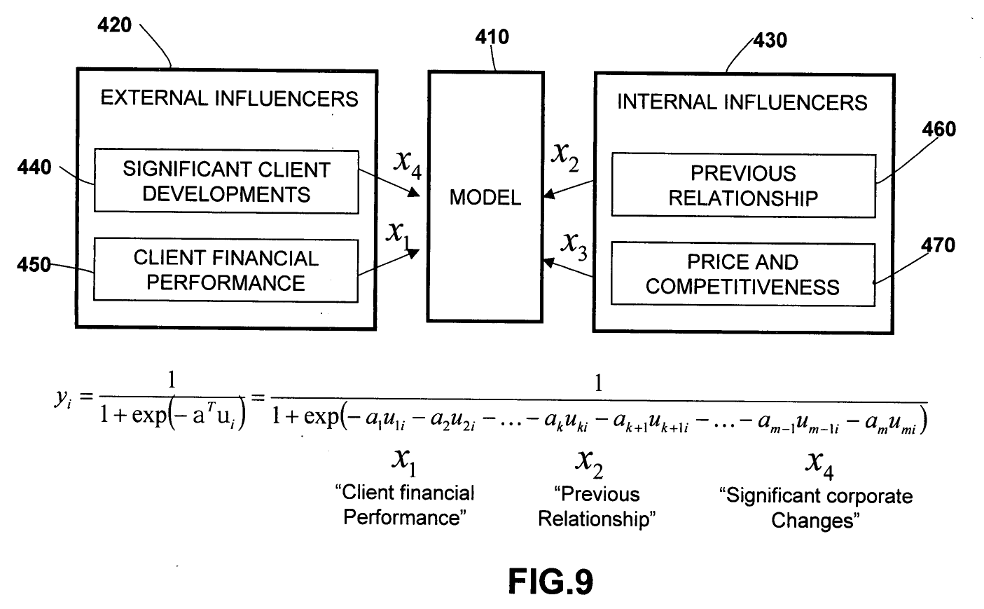

FIG. 9 exemplarily illustrates why the conventional method of FIG. 8 does not provide optimal or reliable results. Specifically, in the exemplary method illustrated in FIG. 8, hidden states are estimated as a by-product of the model (as a weighted linear combination of corresponding inputs). This is not a correct estimate, when there is some partial information about hidden states available (as this information has not been used in determining the parameters of the exemplary model of FIG. 8.)

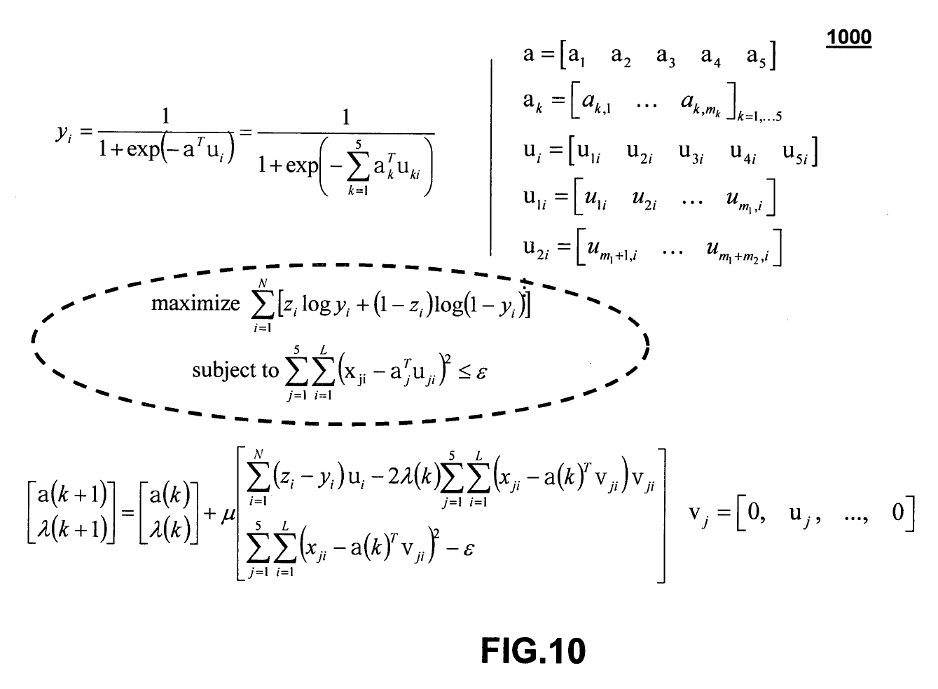

According to the exemplary features of the present invention, it also is desirable to provide a better trained model that will take into account (e.g., adapt to) knowledge about hidden states. FIG. 10 illustrates an exemplary method 1000 of training a model according to the exemplary features of the present invention. Specifically, the exemplary method 1000 maximizes the log-likelihood function, subject to the constraint that the error between the known values of hidden states and estimated values of hidden states is below a predefined threshold.

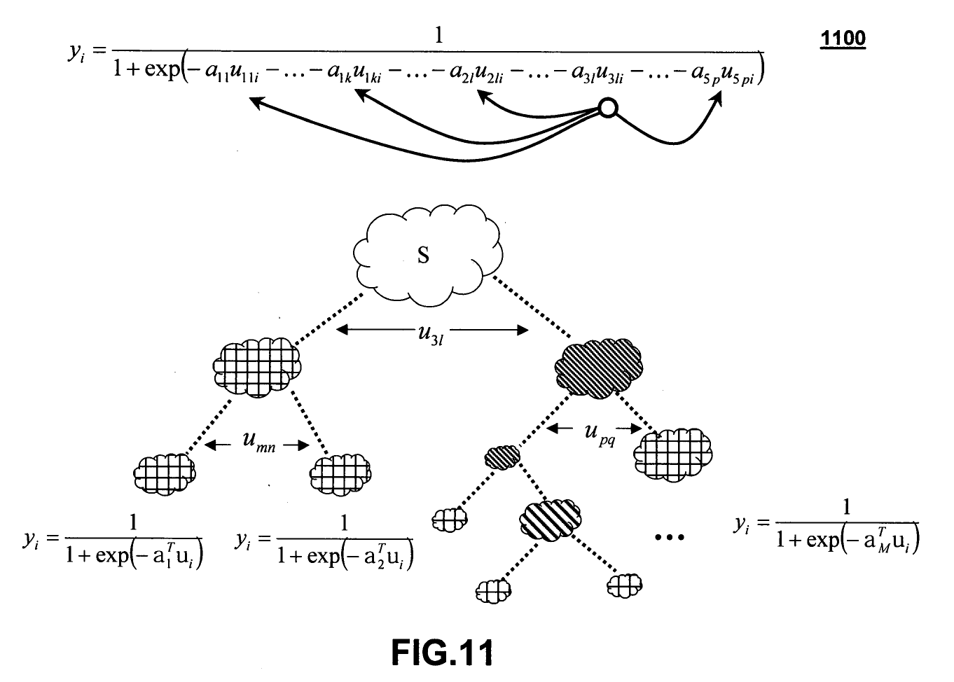

According to the exemplary features of the present invention, it also is desirable to provide a model that will capture non-linear relationships among input variables. FIG. 11 exemplarily illustrates why the conventional systems and methods in which tree-based classifiers, which effectively can capture complex relationships in the data, cannot be applied at all if the training set is small (e.g., the ratio M/K between the number of training M data points and number of K inputs is between 2 and 6). That is, the conventional methods cannot capture hidden relationships and/or cannot deal with very complicated relationships in the data when the data sets are small, and thus, do not work very well and do not provide reliable results.

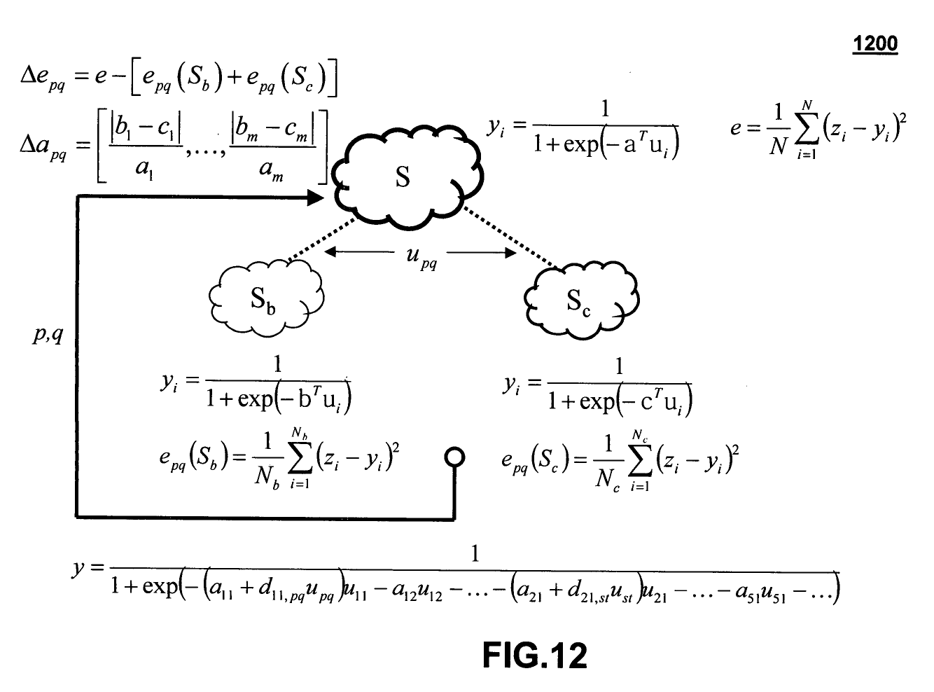

The present invention readjusts the model to determine the relationships, even though the training set is small because instead of splitting the data into several subsets, as is done in conventional methods, and fitting a different model in each subset, an exemplary aspect of the present invention determines the combination of variables that has the largest effect to classification performance, and introduces only these combinations into the model, as illustrated in an exemplary aspect of the present invention in FIG. 12.

That is, the exemplary aspects of the present invention solve the problem of not being able to use complicated models in cases in which the number of data points is small (e.g., there are a lack of data points for the selected model). Specifically, as shown in FIG. 12, the exemplary aspects of the present invention recursively split the data into two nodes, fit a separate model in each node and use the difference in parameter values between the two nodes, to detect if there is a significant cross-interaction between the variables. In an exemplary aspect, only if such interaction exists, a non-linear combination of these variables will be introduced into the model.

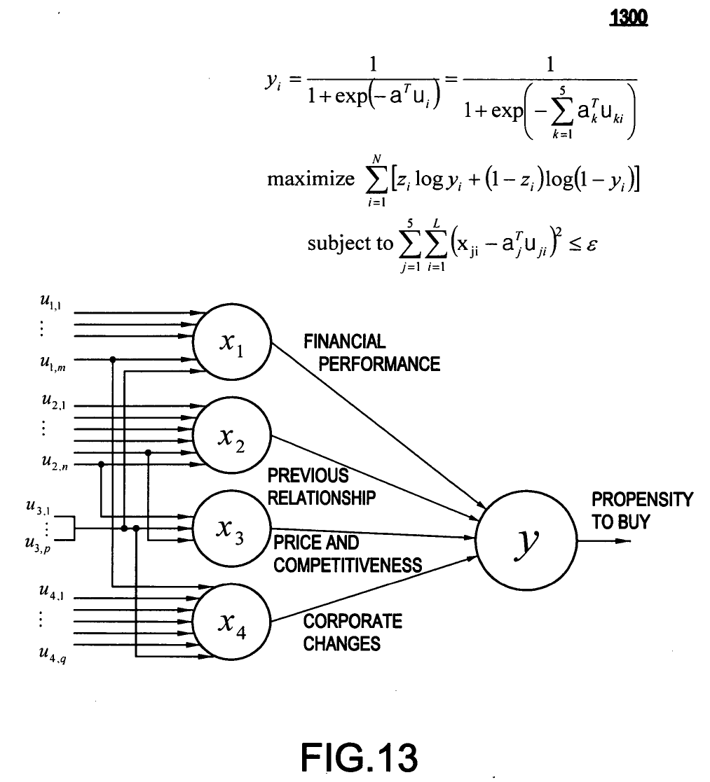

As illustrated in FIG. 13, a final model 1300 can be constructed according to the exemplary aspects of the present invention to train known classifiers to determine partially known hidden states in a model and/or capture relationships between inputs and outputs of the model.

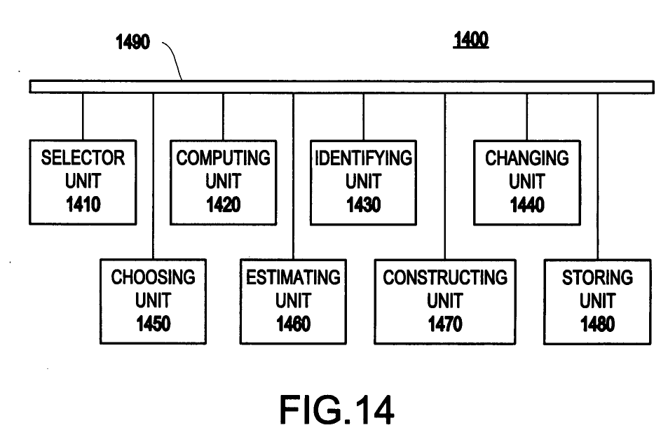

FIG. 14 illustrates an exemplary system according to the present invention that is capable of providing the additional features and advantages described above. For example, a system according to the claimed invention could include selector unit (e.g., 1410) for selecting a model from a plurality of available models and a classifier from a plurality of available classifiers, a choosing unit (e.g., 1450) for choosing an objective function from a plurality of available objective functions for determining hidden states of the selected model, and an estimator unit (e.g., 1460) for estimating parameters of said selected model by optimizing a criterion function for the selected classifier. The units may be coupled together by a bus 1490 or the like.

In another exemplary embodiment, the choosing unit (e.g., 1450) can choose an input variable and construct a one-step tree-classifier with respect to the input variable, while the estimator unit can estimate parameter values at each node of a plurality of nodes by minimizing a classification criterion for the selected classifier. A computing unit (e.g., 1420) can compute a difference between an overall classification criterion function and values of classification criterion functions at two nodes of the plurality of nodes, and a change of each parameter between the two nodes.

In another exemplary embodiment, an identifying unit (e.g., 1430) can identify a combination of variables which results in at least one of a largest decrease in classification criterion and a largest change in parameter values, while a constructing unit (e.g., 1470) can construct a second model by adding new inputs to the first model that reflects at least one relationship between the identified combination of variables. The estimating unit (e.g., 1460) also can re-estimate the parameters of the model, for example, by optimizing the criterion function for the selected classifier.

Another exemplary embodiment also can include a storing unit (e.g., 1480) for storing parameter values, hidden states, and a value of the criterion function, as well as a changing unit (e.g., 1440) for changing the computed values of the hidden states to reflect known relationships to determine second values for the hidden states.

It is noted that the system 1400, as illustrated in FIG. 14, is not limited to any particular arrangement of units and can include some or all of the units (e.g., 1410-1480) illustrated in FIG. 14, in order to perform, for example, the exemplary methods described in the present invention. It would be understandable to the ordinarily skilled artisan that the elements of the exemplary aspect of the invention illustrated in FIG. 14 could be arranged or rearranged to provide the various exemplary aspects of the present invention, as described herein, as well as other exemplary aspects within the spirit and scope of the present invention.

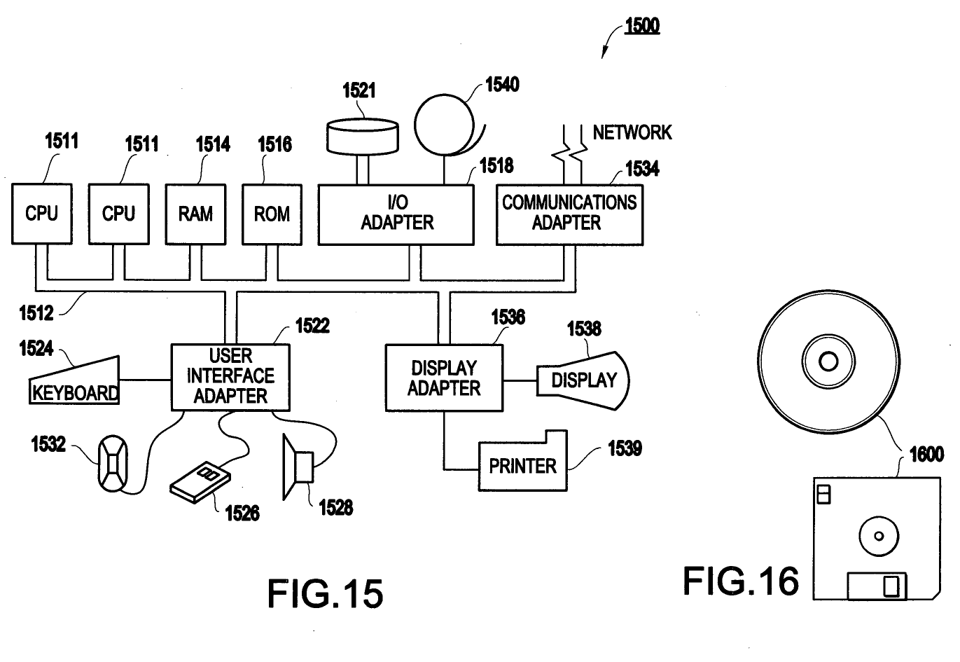

FIG. 15 illustrates an exemplary hardware/information handling system 1500 for incorporating the present invention therein; and FIG. 16 illustrates a signal bearing medium 1600 (e.g., storage medium) for storing steps of a program of a method according to the present invention.

FIG. 15 illustrates a typical hardware configuration of an information handling/computer system for use with the invention and which preferably has at least one processor or central processing unit (CPU) 1511.

The CPUs 1511 are interconnected via a system bus 1512 to a random access memory (RAM) 1514, read-only memory (ROM) 1516, input/output (I/O) adapter 1518 (for connecting peripheral devices such as disk units 1521 and tape drives 1540 to the bus 1512), user interface adapter 1522 (for connecting a keyboard 1524, mouse 1526, speaker 1528, microphone 1532, and/or other user interface device to the bus 1512), a communication adapter 1534 for connecting an information handling system to a data processing network, the Internet, an Intranet, a personal area network (PAN), etc., and a display adapter 1536 for connecting the bus 1512 to a display device 1538 and/or printer.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 1511, as represented by the fast-access storage for example. Alternatively, the instructions may be contained in another signal-bearing media, such as a magnetic data storage diskette 1600 (e.g., see FIG. 16), directly or indirectly accessible by the CPU 1511.

Whether contained in the diskette 1600, the computer/CPU 1511, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

Thus, the illustrative, non-limiting embodiments of the present invention as described above, overcome the problems of the conventional methods and systems, and With the unique and unobvious features of the present invention, a novel system and method is provided for training classifiers and a system and method for estimating model parameters to provide optimal classification results with traditional models, when there is a need to estimate hidden states in the model, when there are complex non-linear relationships between input and output variables, etc.

The exemplary features of the present application provide classification methods, systems, and training procedures for known classifiers that will capture such relationships in the data. Moreover, the exemplary features of the present invention provide simple models, which can be constructed from small training samples to capture the complex input-output relationships.

While the invention has been described in terms of several preferred embodiments, those skilled in the art will recognize that the invention can be practiced with modification within the spirit and scope of the appended claims. Further, it is noted that the inventors' intent is to encompass equivalents of all claim elements, even if amended later during prosecution.

What is claimed is:

1. A method for constructing a linearized classifier including a partially observable hidden state, the method comprising:
training said classifier to determine a partially known hidden state in a model based on a relationship between an input and an output of said model.

2. The method according to claim 1, wherein said training further comprises:
selecting said model from a plurality of models and said classifier from a plurality of classifiers.

3. The method according to claim 1, wherein said training further comprises:
choosing an objective function from a plurality of objective functions for determining hidden states of said model; and
estimating parameters of said model by optimizing a criterion function for said classifier,
wherein said objective function between said hidden states and values computed from said model is less than a predetermined threshold.

4. The method according to claim 2, further comprising:
storing values of said parameters and a value of said criterion function.

5. The method according to claim 2, wherein said model comprises at least one of a linear regression model, a logistic regression model, a nonlinear function model, and a kernel function for a support vector model.

6. The method according to claim 2, wherein said classifier comprises at least one of a maximum likelihood classifier, a minimum mean square error classifier, a maximum a posteriori classifier, and a support vector machine classifier.

7. The method according to claim 3, wherein said objective function comprises a mean square error between partially known values of said hidden states and corresponding values which are observed from said model.

8. The method according to claim 2, further comprising:
choosing an input variable and constructing a one-step tree-classifier with respect to said input variable;
estimating parameter values at each node of a plurality of nodes by minimizing a classification criterion for said classifier;
computing a difference between an overall classification criterion function and values of classification criterion functions at two nodes of said plurality of nodes, and a change of each parameter between said two nodes;
identifying a combination of variables which results in at least one of a largest decrease in classification criterion and a largest change in parameter values;
constructing a second model by adding new inputs to said model that reflect at least one relationship between said identified combination of variables; and
estimating parameters of said second model by minimizing said classification criterion for said classifier.

9. The method according to claim 8, wherein said objective function between partially known hidden states and corresponding values computed from said second model is smaller than a predetermined threshold.

10. The method according to claim 1, wherein said training further comprises:
choosing an input variable and constructing a one-step tree-classifier with respect to said input variable;
estimating parameter values at each node of a plurality of nodes by minimizing a classification criterion for said classifier;
computing a difference between an overall classification criterion function and values of classification criterion functions at two nodes of said plurality of nodes, and a change of each parameter between said two nodes;
identifying a combination of variables which results in at least one of a largest decrease in classification criterion and a largest change in parameter values;
constructing a second model by adding new inputs to said model that reflect at least one relationship between said identified combination of variables; and
estimating parameters of said second model by minimizing said classification criterion for said classifier.

11. The method according to claim 10, wherein an objective function between partially known hidden states and corresponding values computed from said second model is smaller than a predetermined threshold.

12. The method according to claim 10, wherein said at least one relationship comprises a function of said identified combination of variables,
wherein said function includes one of a quadratic term function, a multiplication function, a logistic function, and an exponential function.

13. The method according to claim 10, wherein said choosing, said estimating, and said computing are repeated until all variables of interest are explored.

14. The method according to claim 1, wherein, if there is at least one of no information associated with said partially observable hidden state of a plurality of hidden states, and known relationships between values for some of said hidden states, said training further comprises:
choosing an objective function from a plurality of objective functions for determining hidden states of said model;
estimating parameter values of said model by optimizing a criterion function for said classifier and computing values of said hidden states from said model; and
storing said parameter values, said hidden states, and a value of said criterion function.

15. The method according to claim 14, further comprising:
re-estimating said parameters of said model by optimizing said criterion function for said classifier.

16. The method according to claim 14, wherein said objective function between said new values for said hidden states and said values of said hidden states from said model is less than a predetermined threshold.

17. The method according to claim 14, further comprising:
choosing an input variable and constructing a one-step tree-classifier with respect to said input variable;
estimating parameters at each node of a plurality of nodes by minimizing a classification criterion for said classifier, wherein an objective function between second values of said hidden states which reflect known relationships and corresponding values computed from said model is less than a predetermined threshold;
computing a difference between an overall classification criterion function and values of said classification criterion function at two nodes of said plurality of nodes, and a change of each parameter between said two nodes;
storing said values;
repeating said choosing, said estimating, and said computing until all variables of interest are explored;
identifying a combination of variables which results in at least one of a largest decrease in said classification criterion and a largest change in parameter values;
constructing a second model by adding a new input to said model that reflects a relationship between said identified combination of variables; and
estimating parameters of said second model by minimizing said classification criterion for said classifier.

18. The method according to claim 1, wherein, if there is at least one of no information associated with said partially observable hidden state of a plurality of hidden states, and known relationships between values for some of said hidden states, said training further comprises:
choosing an input variable and constructing a one-step tree-classifier with respect to said input variable;
estimating parameters at each node of a plurality of nodes by minimizing a classification criterion for said classifier,
wherein an objective function between second values of said hidden states which reflect known relationships and corresponding values computed from said model is less than a predetermined threshold;
computing a difference between an overall classification criterion function and values of said classification criterion function at two nodes of said plurality of nodes, and a change of each parameter between said two nodes;
storing said values;
repeating said choosing, said estimating, and said computing until all variables of interest are explored;
identifying a combination of variables which results in at least one of a largest decrease in said classification criterion and a largest change in parameter values;
constructing a second model by adding a new input to said first model that reflects a relationship between said identified combination of variables; and
estimating parameters of said second model by minimizing said classification criterion for said selected classifier,
wherein said objective function between partially known hidden states and corresponding values computed from said model is less than a predetermined threshold.

19. The method according to claim 18, further comprising:
storing values of said parameters and a value of said criterion function.

20. A system of constructing a linearized classifier including a partially observable hidden state, the system comprising:
a training module that trains said classifier to determine a partially known hidden state in said model based on a relationship between an input and an output of said model.

21. The system according to claim 20, wherein said training module further comprises:
a selecting unit that selects said model from a plurality of models and said classifier from a plurality of classifiers.

22. The system according to claim 20, wherein said training module further comprises:
a choosing unit that chooses an objective function from a plurality of objective functions for determining hidden states of said model; and
an estimating unit that estimates parameters of said model by optimizing a criterion function for said classifier,
wherein said objective function between said hidden states and values computed from said model is less than a predetermined threshold.

23. The system according to claim 22, further comprising:
a storing unit that stores values of said parameters and a value of said criterion function.

24. The system according to claim 22, wherein one of said plurality of objective functions comprises a mean square error between partially known values of said hidden states and corresponding values which are observed from said model.

25. The system according to claim 20, wherein said training module further comprises:
a choosing unit that chooses an input variable and constructs a one-step tree-classifier with respect to said input variable;
an estimating unit that estimates parameter values at each node of a plurality of nodes by minimizing a classification criterion for said classifier,
a computing unit that computes a difference between an overall classification criterion function and values of classification criterion functions at two nodes of said plurality of nodes, and a change of each parameter between said two nodes;
an identifying unit that identifies a combination of variables which results in at least one of a largest decrease in classification criterion and a largest change in parameter values; and
a constructing unit that constructs a second model by adding new inputs to said first model that reflect at least one relationship between said identified combination of variables.

26. The system according to claim 25, wherein said choosing unit, said estimating unit, and computing unit are adapted to explore all variables of interest.

27. The system according to claim 20, wherein, if there is at least one of no information associated with said observable hidden state of a plurality of hidden states, and known relationships between values for some of said hidden states, the training module further comprises:
a choosing unit that chooses an objective function from a plurality of objective functions for determining hidden states of said model;
an estimating unit that estimates parameter values of said model by optimizing a criterion function for said classifier and computes values of said hidden states from said model;
a storing unit that stores said parameter values, said hidden states, and a value of said criterion function; and
a changing unit that changes said computed values of said hidden states to reflect known relationships to determine second values for said hidden states.

28. The system according to claim 20, wherein, if there is at least one of no information associated with said observable hidden state of a plurality of hidden states, and known relationships between values for some of said hidden states, the training module further comprises:
a choosing unit that chooses an input variable and constructing a one-step tree-classifier with respect to said input variable;
an estimating unit that estimates parameters at each node of a plurality of nodes by minimizing a classification criterion for said classifier, wherein an objective fimction between second values of said hidden states which reflect known relationships and corresponding values computed from said model is less than a predetermined threshold;
a computing unit that computes a difference between an overall classification criterion function and values of said classification criterion function at two nodes of said plurality of nodes and computes a change of each parameter between said two nodes;
a storing unit that stores said values;
wherein said choosing unit and said estimating unit are adapted to explore all variables of interest;
an identifying unit that identifies a combination of variables which results in at least one of a largest decrease in said classification criterion and a largest change in parameter values; and
a constructing unit that constructs a second model by adding a new input to said first model that reflects a relationship between said identified combination of variables,
wherein said estimating unit estimates parameters of said second model by minimizing said classification criterion for said classifier, and
wherein said objective fimction between partially known hidden states and corresponding values computed from said model is less than a predetermined threshold.

29. A system of constructing a linearized classifier including a partially observable hidden state, the system comprising:
a model; and
means for training said classifier to determine a partially known hidden state in said model based on a relationship between an input and an output of said model.

30. The system according to claim 29, wherein said means for training further comprises:
means for selecting said model from a plurality of models and said classifier from a plurality of classifiers;
means for choosing an objective function from a plurality of objective functions for determining hidden states of said model; and
wherein, if partial information associated with said hidden states is available, said means for training further comprises:
means for estimating parameters of said model by optimizing a criterion function for said classifier,
wherein said objective function between said hidden states and values computed from said model is less than a predetermined threshold.

31. The system according to claim 29, wherein, if at least one of said partial information associated with said hidden states is not available and relationships between said hidden states are available, said system further comprises:
means for estimating parameter values of said model by optimizing a criterion function for said classifier;
means for computing values of said hidden states from said model; and
means for changing said computed values of said hidden states to reflect known relationships to determine second values for said hidden states.

32. The system according to claim 29, further comprising:
means for choosing an input variable and constructing a one-step tree-classifier with respect to said input variable;
means for estimating parameter values at each node of a plurality of nodes by minimizing a classification criterion for said classifier;
means for computing a difference between an overall classification criterion function and values of classification criterion functions at two nodes of said plurality of nodes, and a change of each parameter between said two nodes;
means for identifying a combination of variables which results in at least one of a largest decrease in classification criterion and a largest change in parameter values; and
means for constructing a second model by adding new inputs to said first model that reflect at least one relationship between said identified combination of variables,
wherein said means for estimating estimates parameters of said second model by minimizing said classification criterion for said classifier.

33. A signal-bearing medium tangibly embodying a program of machine-readable instructions executable by a digital processing apparatus to perform a method for constructing a linearized classifier including a partially observable hidden state, the method comprising:
training said classifier to determine a partially known hidden state in said model based on a relationship between an input and an output of said model.

34. A method for deploying computing infrastructure in which computer-readable code is integrated into a computing system, and combines with said computing system to perform a method for constructing a linearized classifier including a partially observable hidden state, said method comprising:
training said classifier to determine a partially known hidden state in said model based on a relationship between an input and an output of said model.

35. A method for constructing a linearized classifier including a partially observable hidden state, the method comprising:
recursively splitting data into two nodes;
fitting a separate model in each node of said two nodes;
based on a difference between parameter values of said two nodes, detecting whether there is a substantial cross-interaction between variables; and
if said cross-interaction exists, introducing a non-linear combination of said variables into said model.
